(19) United States
(12) Patent Application Publication
(10) Pub. No.: US 2026/0050550 A1
(43) Pub. Date: Feb. 19, 2026

(54) MEMORY MANAGEMENT METHOD, ELECTRONIC DEVICE AND STORGAE MEDIUM

(71) Applicant: Beijing Volcano Engine Technology Co., Ltd., Beijing (CN)

(72) Inventors: Shaojun WANG, Beijing (CN); Chunhui MA, Beijing (CN); Chuansheng LU, Beijing (CN); Wangfei TAO, Beijing (CN); Wanqi LI, Beijing (CN); Zhanghao CHEN, Beijing (CN)

(21) Appl. No.: 19/220,982

(22) Filed: May 28, 2025

(30) Foreign Application Priority Data
Aug. 14, 2024 (CN) 202411117843.X

(51) Int. Cl. G06F 12/02; G06F 11/34

(52) U.S. Cl. CPC G06F 12/0253; G06F 11/3476; G06F 12/0246

(57) ABSTRACT

Embodiments of the present disclosure provide a memory management method, electronic device and storage medium. The method includes: obtaining log data of garbage collection performed on a heap memory; obtaining an indicator related to an old generation memory usage amount according to the log data; constructing a memory estimation model by using a frequency of full garbage collection as an independent variable and an estimated capacity of the heap memory as a dependent variable according to the indicator related to the old generation memory usage amount and an original capacity of the heap memory; obtaining a target capacity of the heap memory according to the memory estimation model and an expected frequency of the full garbage collection; and configuring a capacity of the heap memory according to the target capacity of the heap memory.

### CROSS-REFERENCE TO RELATED APPLICATION

This application claims the priority to and benefits of the Chinese Patent Application, No. 202411117843.X which was filed on Aug. 14, 2024. All the aforementioned patent applications are hereby incorporated by reference in their entireties.

### TECHNICAL FIELD

The present disclosure relates to the field of computer science and technology, and in particular, to a memory management method and apparatus.

### BACKGROUND

With continuous development of big data technology and increasing disclosure requirements, requirements of big data for memory management and optimization are getting higher and higher, especially for heap memory management. Due to the complexity of heap memory management and diversity of big data disclosure scenarios, how to efficiently and accurately adapt to a heap memory capacity becomes a technical challenge.

### SUMMARY

In view of this, embodiments of the present disclosure provide a memory management method and apparatus for efficiently and accurately adapting to a heap memory capacity.

To achieve the above purpose, embodiments of the present disclosure provide the following technical solutions.

At least one embodiment of the present disclosure provides a memory management method, including:
obtaining log data of garbage collection performed on a heap memory;
obtaining an indicator related to an old generation memory usage amount according to the log data;
constructing a memory estimation model by using a frequency of full garbage collection as an independent variable and an estimated capacity of the heap memory as a dependent variable according to the indicator related to the old generation memory usage amount and an original capacity of the heap memory;
obtaining a target capacity of the heap memory according to the memory estimation model and an expected frequency of the full garbage collection; and
configuring a capacity of the heap memory according to the target capacity of the heap memory.

As an optional implementation of the embodiment of the present disclosure, the obtaining an indicator related to an old generation memory usage amount according to the log data includes:
obtaining a historical promotion rate, a historical application rate, and a historical survival capacity according to the log data;
where the historical promotion rate is a rate at which a young generation memory is promoted to the old generation memory; the historical application rate is an application rate of the old generation memory; and the historical survival capacity is a size of a survivor object after performing the full garbage collection.

As an optional implementation of the embodiment of the present disclosure, constructing the memory estimation model by using the frequency of the full garbage collection as the independent variable and the estimated capacity of the heap memory as the dependent variable according to the indicator related to the old generation memory usage amount and the original capacity of the heap memory includes:
constructing a first conversion relationship between the estimated capacity of the heap memory and an estimated promotion rate according to the original capacity and the historical promotion rate;
constructing a second conversion relationship between the frequency of the full garbage collection and the estimated capacity of the heap memory according to the historical survival capacity, the historical application rate, and the estimated promotion rate; and
constructing the memory estimation model according to the first conversion relationship and the second conversion relationship.

As an optional implementation of the embodiment of the present disclosure, the constructing a first conversion relationship between the estimated capacity of the heap memory and an estimated constructing the first conversion relationship between the estimated capacity of the heap memory and the estimated promotion rate according to the original capacity of the heap memory and the historical promotion rate includes:
obtaining a first parameter according to a change amount of the estimated capacity of the heap memory relative to the original capacity of the heap memory; and
compensating the historical promotion rate according to the first parameter to obtain the first conversion relationship.

As an optional implementation of the embodiment of the present disclosure, constructing the second conversion relationship between the frequency of the full garbage collection and the estimated capacity of the heap memory according to the historical survival capacity, the historical application rate, and the estimated promotion rate includes:
obtaining a first old generation memory usage amount according to the historical application rate and the frequency of the full garbage collection;
obtaining a second old generation memory usage amount according to the estimated promotion rate and the frequency of the full garbage collection;
constructing a conversion relationship between the old generation memory usage amount and the frequency of the full garbage collection according to the first old generation memory usage amount, the second old generation memory usage amount, and the historical survival capacity; and
generating the second conversion relationship according to the conversion relationship between the old generation memory usage amount and the frequency of the full garbage collection.

As an optional implementation of the embodiment of the present disclosure, configuring the capacity of the heap memory according to the target capacity of the heap memory includes:
obtaining an upper boundary and a lower boundary of the capacity of the heap memory according to the original capacity of the heap memory;
determining whether the target capacity of the heap memory is greater than the lower boundary and less than the upper boundary;
in response to the target capacity of the heap memory being greater than the lower boundary and less than the upper boundary, configuring the target capacity of the heap memory as the capacity of the heap memory;
in response to the target capacity of the heap memory being less than or equal to the lower boundary, configuring the lower boundary as the capacity of the heap memory; and
in response to the target capacity of the heap memory being greater than or equal to the upper boundary, configuring the upper boundary as the capacity of the heap memory.

As an optional implementation of the embodiment of the present disclosure, configuring the capacity of the heap memory according to the target capacity of the heap memory includes:
obtaining an upper boundary and a lower boundary of the capacity of the heap memory according to the original capacity of the heap memory;
normalizing the target capacity of the heap memory based on the upper boundary and the lower boundary to obtain a normalization value of the target capacity of the heap memory;
obtaining a denormalization value of the target capacity of the heap memory according to the normalization value, the upper boundary, and the lower boundary; and
configuring the denormalization value as the capacity of the heap memory.

As an optional implementation of the embodiment of the present disclosure, obtaining the indicator related to the old generation memory usage amount according to the log data includes:
parsing the log data to obtain a historical garbage collection event;
using a K-Means classification algorithm to cluster the historical garbage collection event into two clusters by using an occurrence frequency as a feature; and
obtaining the indicator related to the old generation memory usage amount through a historical garbage collection event in a cluster with a higher occurrence frequency in the two clusters.

As an optional implementation of the embodiment of the present disclosure, obtaining the log data of the garbage collection performed on the heap memory includes:
obtaining log data of garbage collection performed by a JVM in a stream processing service system.

At least one embodiment of the present disclosure provides a memory management apparatus, including:
an obtaining unit, configured to obtain log data of garbage collection performed on a heap memory;
a parsing unit, configured to obtain an indicator related to an old generation memory usage amount according to the log data;
a constructing unit, configured to construct a memory estimation model by using a frequency of full garbage collection as an independent variable and an estimated capacity of the heap memory as a dependent variable according to the indicator related to the old generation memory usage amount and an original capacity of the heap memory;
a processing unit, configured to obtain a target capacity of the heap memory according to the memory estimation model and an expected frequency of the full garbage collection; and
a configuration unit, configured to configure a capacity of the heap memory according to the target capacity of the heap memory.

As an optional implementation of the embodiment of the present application, the parsing unit is further configured to obtain a historical promotion rate, a historical application rate, and a historical survival capacity according to the log data;
where the historical promotion rate is a rate at which a young generation memory is promoted to the old generation memory; the historical application rate is an application rate of the old generation memory; and the historical survival capacity is a size of a survivor object after performing the full garbage collection.

As an optional implementation of the embodiment of the present disclosure, the constructing unit is further configured to construct a first conversion relationship between the estimated capacity of the heap memory and an estimated promotion rate according to the original capacity of the heap memory and the historical promotion rate; construct a second conversion relationship between the frequency of the full garbage collection and the estimated capacity of the heap memory according to the historical survival capacity, the historical application rate, and the estimated promotion rate; and construct the memory estimation model according to the first conversion relationship and the second conversion relationship.

As an optional implementation of the embodiment of the present disclosure, the constructing unit is further configured to obtain a first parameter according to a change amount of the estimated capacity of the heap memory relative to the original capacity of the heap memory; and compensate the historical promotion rate according to the first parameter to obtain the first conversion relationship.

As an optional implementation of the embodiment of the present disclosure, the constructing unit is further configured to obtain a first old generation memory usage amount according to the historical application rate and the frequency of the full garbage collection; obtain a second old generation memory usage amount according to the estimated promotion rate and the frequency of the full garbage collection; construct a conversion relationship between the old generation memory usage amount and the frequency of the full garbage collection according to the first old generation memory usage amount, the second old generation memory usage amount, and the historical survival capacity; and generate the second conversion relationship according to the conversion relationship between the old generation memory usage amount and the frequency of the full garbage collection.

As an optional implementation of the embodiment of the present disclosure, the configuration unit is further configured to obtain an upper boundary and a lower boundary of the heap memory capacity according to the original capacity of the heap memory; determine whether the target capacity of the heap memory is greater than the lower boundary and less than the upper boundary; in response to the target capacity of the heap memory being greater than the lower boundary and less than the upper boundary, configure the target capacity of the heap memory as the capacity of the heap memory; in response to the target capacity of the heap memory being less than or equal to the lower boundary, configure the lower boundary as the capacity of the heap memory; or in response to the target capacity of the heap memory being greater than or equal to the upper boundary, configure the upper boundary as the capacity of the heap memory.

As an optional implementation of the embodiment of the present disclosure, the configuration unit is further configured to obtain an upper boundary and a lower boundary of the heap memory capacity according to the original capacity of the heap memory; normalize the target capacity of the heap memory based on the upper boundary and the lower boundary to obtain a normalization value of the target capacity of the heap memory; obtain a denormalization value of the target capacity of the heap memory according to the normalization value, the upper boundary, and the lower boundary; and configure the denormalization value as the capacity of the heap memory.

As an optional implementation of the embodiment of the present disclosure, the parsing unit is further configured to parse the log data to obtain a historical garbage collection event; use a K-Means classification algorithm to cluster the historical garbage collection event into two clusters by using an occurrence frequency as a feature; and obtain the indicator related to the old generation memory usage amount through a historical garbage collection event in a cluster with a higher occurrence frequency in the two clusters.

As an optional implementation of the embodiment of the present disclosure, the obtaining unit is further configured to obtain log data of garbage collection performed on a heap memory of a Java virtual machine in a stream processing service system.

At least one embodiment of the present disclosure provides an electronic device, including a memory and a processor. The memory is configured to store a computer program, and the processor is configured to, when executing the computer program, enable the electronic device to perform the memory management method according to any one of the above implementations.

At least one an embodiment of the present disclosure provides a computer-readable storage medium. When a computer program is executed by a computing device, the computing device is enabled to perform the memory management method according to any one of the above implementations.

At least one embodiment of the present disclosure provides a computer program product. When the computer program product runs on a computer, the computer is enabled to perform the memory management method according to any one of the above implementations.

### BRIEF DESCRIPTION OF DRAWINGS

The drawings, which are incorporated in and constitute a part of this specification, illustrate embodiments consistent with the present disclosure and, together with the description, serve to explain the principles of the present disclosure.

In order to more clearly illustrate the technical solutions in the embodiments of the present disclosure, the following briefly introduces the drawings required for describing the embodiments or the prior art. Apparently, the drawings in the following description show some embodiments of the present disclosure, and a person of ordinary skill in the art may still derive other drawings from these drawings without creative efforts.

FIG. 1 is a flowchart for interaction of a memory management method according to an embodiment of the present disclosure.

FIG. 2 is a flowchart for interaction of a memory management method according to an embodiment of the present disclosure.

FIG. 3 is a schematic structural diagram of a memory management apparatus according to an embodiment of the present disclosure.

FIG. 4 is a schematic diagram of a hardware structure of an electronic device according to an embodiment of the present disclosure.

### DETAILED DESCRIPTION

To more clearly understand the above objectives, features, and advantages of the present disclosure, the solutions of the present disclosure are further described below. It should be noted that the embodiments of the present disclosure and features in the embodiments may be combined with each other without conflict.

Many specific details are set forth in the following description to facilitate full understanding of the present disclosure. However, the present disclosure may be implemented in other manners different from those described herein. Apparently, the embodiments described in the specification are merely some embodiments of the present disclosure, but not all embodiments.

In the embodiments of the present disclosure, the word such as “exemplary” or “for example” is used to represent giving an example, an illustration, or a description. Any embodiment or design scheme described as “exemplary” or “for example” in the embodiments of the present disclosure should not be interpreted as being more preferable or advantageous than other embodiments or design schemes. Specifically, the word such as “exemplary” or “for example” is used to present related concepts in a specific manner. In addition, in the description of the embodiments of the present disclosure, unless otherwise specified, the term “a plurality of” means two or more.

When heap memory is configured, in response to configured memory resources being excessive, resources may be wasted, and system deployment costs may be increased; in response to the configured memory resources being too small, the service performance and stability may be affected. At present, in terms of heap memory configuration and optimization, a manner mainly depends on personal experience and trial and error. On one hand, this requires a user to have related knowledge of memory management, and a professional threshold is relatively high. On the other hand, heap memory optimization often needs to be adjusted and tested repeatedly, and can only be optimized for a single service one by one, which is inefficient and difficult to cope with a large-capacity stream processing service scenario. Therefore, how to efficiently and accurately adapt to a capacity of the heap memory is a problem to be urgently solved.

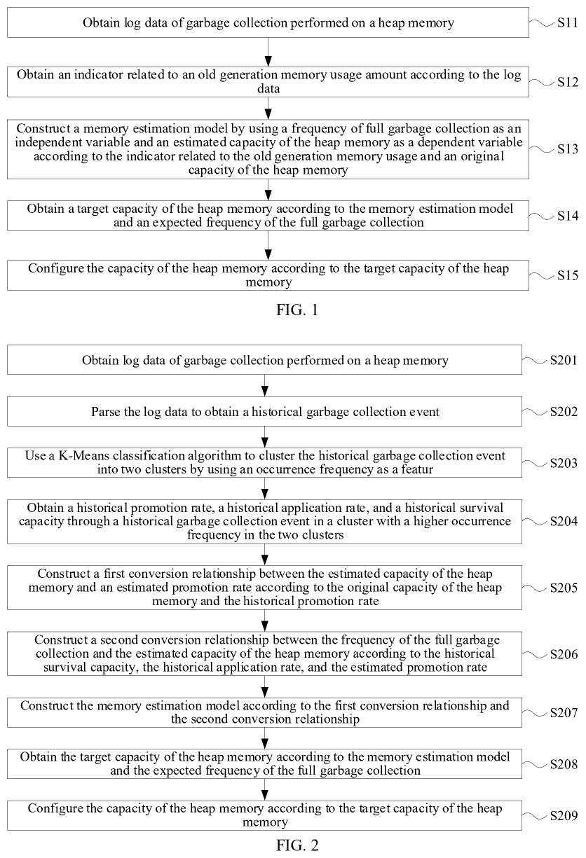

An embodiment of the present disclosure provides a memory management method. Referring to FIG. 1, the memory management method includes the following steps.
S11: Obtain log data of garbage collection performed on a heap memory.

The garbage collection is a mechanism for memory management. When the memory occupied by an object that is no longer used needs to be reclaimed for reuse, the program performs the garbage collection. The main purpose of garbage collection is to release the memory space occupied by the object that is no longer referenced, so as to avoid memory leakage and improve memory usage efficiency.

The heap memory in the embodiment of the present disclosure may be a memory area allocated for a specific object to dynamically store data. For example, the heap memory may be a heap memory allocated by a Java virtual machine (Java Virtual Machine, JVM); for another example, the heap memory may be a heap memory allocated for an object and an array in a C language or a C++ language; for another example, the heap memory may be a heap memory allocated by an image processing program to store image data. The embodiment of the present disclosure does not limit an object to which the heap memory belongs and a programming language used by the object.

In some embodiments, the log data of garbage collection may include one or more of the number of times of garbage collection, a time of garbage collection, a heap memory usage before garbage collection, a heap memory usage after garbage collection, and an efficiency indicator of garbage collection.

In some embodiments, the above step S11 (obtaining log data of garbage collection performed on a heap memory) includes: obtaining log data of garbage collection performed on a heap memory of a Java virtual machine (Java Virtual Machine, JVM) in a stream processing service system.

That is, the log data is log data generated by garbage collection performed by the JVM in the stream processing service system, and the memory management method provided in the embodiment of the present disclosure can perform estimation and configuration on the heap memory of the JVM in the stream processing service system.

In some embodiments, the stream processing service system may be an Apache Flink service system.
S12: Obtain an indicator related to an old generation memory usage amount according to the log data.

In a generational memory management mechanism, a heap memory is generally divided into a young generation memory and an old generation memory for management. The young generation memory is managed by using a copying algorithm, and is divided into an initial area (Eden) and two survivor areas (Survivor). When the Eden area is full, a Minor GC (garbage collection of the young generation memory) is triggered. A survivor object in the Eden area is copied from the Eden area to a first Survivor area, and a survivor object in the first Survivor area is copied from the Eden area to a second Survivor area. An object that still survives after multiple times of Minor GC and reaches a preset age is promoted to the old generation memory. The old generation memory is managed by using a compaction algorithm. As the old generation memory continues to grow, the old generation memory reaches a set threshold. When the set threshold is reached, full garbage collection (Full GC) is triggered to reclaim and reuse a memory space occupied by a dead object in the full heap memory (including the young generation memory and the old generation memory).

The old generation memory usage amount includes three parts: 1. a memory occupied by a survivor object after the full garbage collection; 2. a memory occupied by an object promoted from the young generation memory to the old generation memory; and 3. a memory occupied by a Humongous (a large object, an object directly applied for in the old generation memory). Therefore, the indicator related to the old generation memory usage amount may include indicators related to the three parts, for example, the memory occupied by the survivor object after the full garbage collection, a rate of the memory occupied by the survivor object after the full garbage collection, a rate of applying for a Humongous, and the like.
S13: Construct a memory estimation model by using a frequency of full garbage collection as an independent variable and an estimated capacity of the heap memory as a dependent variable according to the indicator related to the old generation memory usage amount and an original capacity of the heap memory

Since the full garbage collection needs to be performed after all service threads are paused, and all objects in the heap memory need to be marked, the duration of the full garbage collection is much longer than the duration of the Minor GC, and the impact on the service is also greater. When the full garbage collection is triggered too frequently, for example, the full garbage collection is triggered once every few seconds, the service will be greatly affected, indicating that the service is in an unhealthy state. When the full garbage collection is triggered too infrequently, for example, the full garbage collection is triggered only once a day, it indicates that the heap memory has a large optimization space. Therefore, the frequency of the full garbage collection is a key indicator reflecting whether the service is healthy. The memory estimation model constructed by using the frequency of the full garbage collection as the independent variable and the estimated capacity of the heap memory as the dependent variable can accurately estimate the required capacity of the heap memory.
S14: Obtain a target capacity of the heap memory according to the memory estimation model and an expected frequency of the full garbage collection.

That is, the expected frequency of the full garbage collection which is expected to be reached is preset, and the target capacity of the heap memory is obtained by substituting the expected frequency of the full garbage collection into the memory estimation model.

In some embodiments, the expected frequency of the full garbage collection may be set by balancing requirements of service performance and stability and memory deployment costs. The higher the expected frequency of the full garbage collection, the lower the memory deployment costs, but the worse the service performance and stability. On the contrary, the lower the expected frequency of the full garbage collection, the better the service performance and stability, but the higher the memory deployment costs.
S15: Configure the capacity of the heap memory according to the target capacity of the heap memory.

In some embodiments, the configuring the capacity of the heap memory according to the target capacity of the heap memory includes:
configuring the target capacity of the heap memory as the capacity of the heap memory. For example, when the target capacity of the heap memory is 20 MB, the capacity of the heap memory is configured to 20 MB.

The memory management method provided in the embodiment of the present disclosure includes: first, obtaining log data of garbage collection performed on a heap memory, and obtaining an indicator related to an old generation memory usage amount according to the log data; then, constructing a memory estimation model by using a frequency of the full garbage collection as an independent variable and an estimated capacity of the heap memory as a dependent variable according to the indicator related to the old generation memory usage amount and an original capacity of the heap memory of the heap memory; then, obtaining a target capacity of the heap memory according to the memory estimation model and an expected frequency of the full garbage collection; and configuring a capacity of the heap memory according to the target capacity of the heap memory. In the memory management method provided in the embodiment of the present disclosure, the memory estimation model may be constructed by using the frequency of the full garbage collection as a variable and the estimated capacity of the heap memory as the dependent variable according to the indicator related to the old generation memory usage amount and the original capacity of the heap memory. After the expected frequency of the full garbage collection is set, the target capacity of the heap memory corresponding to the expected frequency of the full garbage collection may be obtained according to the memory estimation model, and the capacity of the heap memory is configured according to the target capacity of the heap memory. This does not require a user to have related background knowledge of memory management, and does not require individual optimization for a single service. Therefore, the above embodiment can efficiently and accurately adapt to the capacity of the heap memory.

As an expansion and refinement of the above embodiment, an embodiment of the present disclosure provides another memory management method. Referring to FIG. 2, the memory management method includes the following steps.
S201: Obtain log data of garbage collection performed on a heap memory.
S202: Parse the log data to obtain a historical garbage collection event.

In some embodiments, the log data may be parsed by using a CG parsing tool to obtain the historical garbage collection event.
S203: Use a K-Means classification algorithm to cluster the historical garbage collection event into two clusters by using an occurrence frequency as a feature.

The K-Means classification algorithm is an unsupervised learning algorithm, and is used to cluster a data set into a specified number (K) of clusters based on a clustering feature.

In some embodiments, the using a K-Means classification algorithm to cluster the historical garbage collection event into two clusters by using an occurrence frequency as a feature includes the following steps a to d.

In step a, two historical garbage collection events are randomly selected as initial clustering centers.

In step b, for each historical garbage collection event, a distance from the historical garbage collection event to each of the two clustering centers is calculated based on the occurrence frequency, and the historical garbage collection event is allocated to a cluster to which the closest clustering center belongs.

In step c, an average value of all historical garbage collection events in the two clusters is recalculated and used as a new clustering center.

In step d, steps b and c are repeated until there is no significant change in the clustering center or a predetermined number of iterations is reached.
S204: Obtain a historical promotion rate, a historical application rate, and a historical survival capacity through a historical garbage collection event in a cluster with a higher occurrence frequency in the two clusters.

The historical promotion rate is a rate at which the young generation memory is promoted to the old generation memory. The historical application rate is an application rate of the old generation memory. The historical survival capacity is a size of a survivor object after the full garbage collection is performed.

A service generally has obvious peak and trough characteristics. In the above embodiment, the historical garbage collection event is clustered into the two clusters by using the occurrence frequency as the feature, and the historical promotion rate, the historical application rate, and the historical survival capacity are obtained through the historical garbage collection event in the cluster with the higher occurrence frequency in the two clusters. Therefore, in the above embodiment, the obtained target capacity of the heap memory can meet a performance requirement in a peak period of the service.

In some embodiments, the historical promotion rate may be a ratio of a total amount of the young generation memory promoted to the old generation memory to a length of a specified historical time period in the specified historical time period, with a unit of MB/minute.

In some embodiments, the historical application rate may be a ratio of a total amount of memory applied for by a Humongous (an object directly applied for in the old generation memory) to a length of a specified historical time period in the specified historical time period, with a unit of MB/minute.

In some embodiments, the historical survival capacity may be an average value of a size of the survivor object after each full garbage collection, with a unit of MB. For example, when the full garbage collection is performed four times, and sizes of the survivor object after the four times of full garbage collection are A, B, C, and D, respectively, the historical survival capacity may be (A+B+C+D)/4.
S205: Construct a first conversion relationship between the estimated capacity of the heap memory and an estimated promotion rate according to the original capacity of the heap memory and the historical promotion rate.

After the capacity of the heap memory is adjusted, when an application rate of a service object remains unchanged, an object promotion rate may change. A change trend is as follows: When the capacity of the heap memory increases, a rate at which the young generation memory is promoted to the old generation memory becomes smaller. When the capacity of heap memory decreases, the rate at which the young generation memory is promoted to the old generation memory becomes greater. Therefore, compensation may be performed based on the historical promotion rate to obtain a conversion relationship between the changed capacity of the heap memory (the estimated capacity of the heap memory) and the estimated promotion rate.

In some embodiments, the constructing a first conversion relationship between the estimated capacity of the heap memory and an estimated promotion rate according to the original capacity of the heap memory and the historical promotion rate includes the following steps S2051 and S2052.
S2051: Obtain a first parameter according to a change amount of the estimated capacity of the heap memory relative to the original capacity of the heap memory.

In some embodiments, the obtaining a first parameter according to a change amount of the estimated capacity of the heap memory relative to the original capacity of the heap memory includes obtaining the first parameter according to the following formula.

$$G \% = \frac{HeapEst - HeapOrig}{HeapEst + HeapOrig}$$

G % is the first parameter, HeapEst is the estimated capacity of the heap memory, and HeapOrig is the original capacity of the heap memory.
S2052: Compensate the historical promotion rate according to the first parameter to obtain the first conversion relationship.

In some embodiments, the first conversion relationship may be expressed as:

$${PR}_{Adjust} = {PR}_{Orig} * ( 1 - β * \frac{HeapEst - HeapOrig}{HeapEst + HeapOrig} )$$

PR_{Adjust} is the estimated promotion rate, PR_{Orig} is the historical promotion rate, HeapEst is the estimated capacity of the heap memory, HeapOrig is the original capacity of the heap memory, and β is a constant.

In some embodiments, β may be an empirical parameter set by a person skilled in the art.

In some embodiments, the first conversion relationship may alternatively be transformed. For example, the first conversion relationship is transformed into:

$$\{ \begin{matrix}G \% = \frac{HeapEst - HeapOrig}{HeapEst + HeapOrig} \\ {PR}_{Adjust} = {PR}_{Orig} * ( 1 - β * G \% )\end{matrix}$$

However, this transformation is merely an equivalent replacement of the first conversion relationship, and does not make the essence of the first conversion relationship deviate from the scope of the technical solutions of the above embodiments.
S206: Construct a second conversion relationship between the frequency of the full garbage collection and the estimated capacity of the heap memory according to the historical survival capacity, the historical application rate, and the estimated promotion rate.

As described above, the old generation memory usage amount includes three parts: 1. the memory occupied by the survivor object after the full garbage collection; 2. the memory occupied by the object promoted from the young generation memory to the old generation memory; and 3. the memory applied for by the Humongous. Therefore, the memory occupied by the three parts is summed, and then a coefficient is multiplied by a summation result according to a proportion of the capacity of the old generation memory to the capacity of the young generation memory to obtain the required capacity of the heap memory. Therefore, the second conversion relationship between the frequency of the full garbage collection and the estimated capacity of the heap memory may be constructed according to the historical survival capacity, the historical application rate, and the estimated promotion rate.

In some embodiments, the constructing the second conversion relationship between the frequency of the full garbage collection and the estimated capacity of the heap memory according to the historical survival capacity, the historical application rate, and the estimated promotion rate includes the following steps S2061 to S2064.
S2061: Obtain the first old generation memory usage amount according to the historical application rate and the frequency of the full garbage collection.

The historical application rate is expressed as HR, the frequency of the full garbage collection is expressed as P_{FullGC}, and the first old generation memory usage amount is expressed as H_{Old}. Therefore, the following is obtained:

$${H}_{Old} = HR * {P}_{FullGC}$$

S2062: Obtain the second old generation memory usage amount according to the estimated promotion rate and the frequency of the full garbage collection.

The estimated promotion rate is expressed as PR_{Adjust}, the frequency of the full garbage collection is expressed as P_{FullGC}, and the second old generation memory usage amount is expressed as H_{Old}. Therefore, the following is obtained:

$${P}_{Old} = {PR}_{Adjust} * {P}_{FullGC}$$

S2063: Construct the conversion relationship between the old generation memory usage amount and the frequency of the full garbage collection according to the first old generation memory usage amount, the second old generation memory usage amount, and the historical survival capacity.

As described above, the old generation memory usage amount includes three parts: 1. the memory occupied by the survivor object after the full garbage collection; 2. the memory occupied by the object promoted from the young generation memory to the old generation memory; and 3. the memory applied for by the Humongous. Therefore, the conversion relationship between the old generation memory usage amount and the frequency of the full garbage collection may be:

$${T}_{Old} = {A}_{FullGC} + {H}_{Old} + {P}_{Old} = {A}_{FullGC} + ( HR + {PR}_{Adjust} ) * {P}_{FullGC}$$

T_{Old} is the old generation memory usage amount, A_{FullGC} is the historical survival capacity, HR is the historical application rate, PR_{Adjust} is the estimated promotion rate, and P_{FullGC} is the frequency of the full garbage collection.
S2064: Generate the second conversion relationship according to the conversion relationship between the old generation memory usage amount and the frequency of the full garbage collection.

In some embodiments, the generating the second conversion relationship according to the conversion relationship between the old generation memory usage amount and the frequency of the full garbage collection includes: generating the second conversion relationship according to a proportion of the old generation memory in the heap memory and the conversion relationship between the old generation memory usage amount and the frequency of the full garbage collection.

In some embodiments, the proportion of the old generation memory in the heap memory is ⅔, and the second conversion relationship may be:

$$HeapEst = [ {A}_{FullGC} + ( HR + {PR}_{Adjust} ) * {P}_{FullGC} ] * 1.5$$

HeapEst is the estimated capacity of the heap memory, A_{FullGC} is the historical survival capacity, HR is the historical application rate, PR_{Adjust} is the estimated promotion rate, and P_{FullGC} is the frequency of the full garbage collection.

In some embodiments, the second conversion relationship may alternatively be transformed. For example, the second conversion relationship is transformed into:

$$\{ \begin{matrix}{P}_{FullGC} = \frac{24 * 60}{{C}_{FullGC}} \\ HeapEst = [ {A}_{FullGC} + ( HR + {PR}_{Adjust} ) * {P}_{FullGC} ] * 1.5\end{matrix}$$

C_{FullGC} is the number of times of full garbage collection per day (every 24 hours).
S207: Construct the memory estimation model according to the first conversion relationship and the second conversion relationship.

A quadratic equation of one variable for the estimated capacity of the heap memory may be obtained by combining the first conversion relationship and the second conversion relationship. The quadratic equation of one variable for the estimated capacity of the heap memory is the memory estimation model. A quadratic equation of one variable with the frequency of the full garbage collection as the independent variable and the estimated capacity of the heap memory as the dependent variable may be obtained by substituting the known quantities such as the historical survival capacity, the historical application rate, and the estimated promotion rate into the quadratic equation of one variable.

In some embodiments, the memory estimation model is:

$$\{ \begin{matrix}HeapEst = \frac{- b \pm \sqrt{{b}^{2} - 4 c}}{2} ( HeapEst > 0 ) \\ b = HeapOrig - 1.5 {A}_{FullGC} - 1.5 {P}_{FullGC} * ( HR + {PR}_{Orig} - β * {PR}_{Orig} ) \\ c = - 1.5 HeapOrig * [ {A}_{FullGC} + {P}_{FullGC} * ( HR + {PR}_{Orig} + β * {PR}_{Orig} ) ]\end{matrix}$$

HeapEst is the estimated capacity of the heap memory, HeapOrig is the original capacity of the heap memory, A_{FullGC} is the historical survival capacity, P_{FullGC} is the frequency of the full garbage collection, HR is the historical application rate, PR_{Orig} is the historical promotion rate, and β is a constant.

Similarly, the memory estimation model may be transformed. For example, the memory estimation model is transformed into:

$$\{ \begin{matrix}a * {HeapEst}^{2} + b * HeapEst + c = 0 \\ HeapEst = \frac{- b \pm \sqrt{{b}^{2} - 4 ac}}{2 a} ( HeapEst > 0 ) \\ a = 1 \\ b = HeapOrig - 1.5 {A}_{FullGC} - 1.5 {P}_{FullGC} * ( HR + {PR}_{Orig} - β * {PR}_{Orig} ) \\ c = - 1.5 HeapOrig * [ {A}_{FullGC} + {P}_{FullGC} * ( HR + {PR}_{Orig} + β * {PR}_{Orig} ) ]\end{matrix}$$

S208: Obtain the target capacity of the heap memory according to the memory estimation model and the expected frequency of the full garbage collection.

As described above, the quadratic equation of one variable with the frequency of the full garbage collection as the independent variable and the estimated capacity of the heap memory as the dependent variable may be obtained by substituting the known quantities such as the historical survival capacity, the historical application rate, and the estimated promotion rate into the quadratic equation of one variable. The quadratic equation of one variable is solved by substituting the expected frequency of the full garbage collection into the quadratic equation of one variable to obtain the capacity of the heap memory corresponding to the expected frequency of the full garbage collection.
S209: Configure the capacity of the heap memory according to the target capacity of the heap memory.

In some embodiments, the configuring the capacity of the heap memory according to the target capacity of the heap memory includes: configuring the target capacity of the heap memory as the capacity of the heap memory.

In some embodiments, the configuring the capacity of the heap memory according to the target capacity of the heap memory includes the following steps a to e.

In step a, the upper boundary and the lower boundary of the capacity of the heap memory are obtained according to the original capacity of the heap memory.

In some embodiments, the upper boundary of the capacity of the heap memory is (1+30%)*the original capacity of the heap memory, and the lower boundary of the capacity of the heap memory is (1−30%)*the original capacity of the heap memory. For example, when the original capacity of the heap memory is 10 MB, the upper boundary and the lower boundary of the capacity of the heap memory are 13 MB and 7 MB, respectively.

In step b, determine whether the target capacity of the heap memory is greater than the lower boundary and less than the upper boundary.

In the above step b, in response to the target capacity of the heap memory being greater than the lower boundary and less than the upper boundary, the following step c is performed. In response to the target capacity of the heap memory being less than or equal to the lower boundary, the following step d is performed. In response to the target capacity of the heap memory being greater than or equal to the upper boundary, the following step e is performed.

In step c, configure the target capacity of the heap memory as the capacity of the heap memory.

In step d, configure the lower boundary as the capacity of the heap memory.

In step e, configure the upper boundary as the capacity of the heap memory.

In the above embodiment, when the target capacity of the heap memory is less than or equal to the lower boundary, the lower boundary is configured as the capacity of the heap memory. When the target capacity of the heap memory is less than or equal to the lower boundary, the lower boundary is configured as the capacity of the heap memory. When the target capacity of the heap memory is greater than or equal to the upper boundary, the upper boundary is configured as the capacity of the heap memory. Therefore, the configured capacity of the heap memory is always within the range of the upper boundary and the lower boundary of the capacity of the heap memory. Therefore, the above embodiment can avoid an excessively large adjustment of the capacity of the heap memory, thereby affecting the estimation accuracy of the object promotion rate.

In some embodiments, the configuring the capacity of the heap memory according to the target capacity of the heap memory includes the following steps 1 to 4.

In step 1, obtain the upper boundary and the lower boundary of the capacity of the heap memory according to the original capacity of the heap memory.

In step 2, normalize the target capacity of the heap memory based on the upper boundary and the lower boundary to obtain a normalization value of the target capacity of the heap memory.

In some embodiments, the normalizing the target capacity of the heap memory based on the upper boundary and the lower boundary includes: normalizing the target capacity of the heap memory based on a sigmoid function, the upper boundary, and the lower boundary.

Exemplarily, the process of obtaining the normalization value of the target capacity of the heap memory is described below by using an example in which the normalization function is a sigmoid function, the upper boundary is 13, the lower boundary is 7, and the target capacity of the heap memory is 15.

First, 15 is mapped to the interval [0, 1] to obtain: (15−7)/(13−7)=4/3.

Then, 4/3 is substituted into the sigmoid function to obtain:

$$Sigmoid ( 4 / 3 ) = \frac{1}{1 + {e}^{- 4 / 3}} \approx 0.908$$

Exemplarily, the process of obtaining the normalization value of the target capacity of the heap memory is described below by using an example in which the normalization function is a sigmoid function, the upper boundary is 13, the lower boundary is 7, and the target capacity of the heap memory is 12.

First, 12 is mapped to the interval [0, 1] to obtain: (12−7)/(13−7)=5/6.

Then, 5/6 is substituted into the sigmoid function to obtain:

$$Sigmoid ( 5 / 6 ) = \frac{1}{1 + {e}^{- 5 / 6}} \approx 0.885$$

In step 3, the denormalization value of the target capacity of the heap memory is obtained according to the normalization value, the upper boundary, and the lower boundary.

As shown in the above example, when the upper boundary is 13, the lower boundary is 7, and the target capacity of the heap memory is 15, the normalization value is 0.908. The denormalization value of the target capacity of the heap memory obtained according to the normalization value, the upper boundary, and the lower boundary is 7+0.908*(13−7)=12.448.

As shown in the above example, when the upper boundary is 13, the lower boundary is 7, and the target capacity of the heap memory is 15, the normalization value is 0.885. The denormalization value of the target capacity of the heap memory obtained according to the normalization value, the upper boundary, and the lower boundary is 7+0.885*(13−7)=12.31.

In step 4, the denormalization value is configured as the capacity of the heap memory.

In the above embodiment, the upper boundary and the lower boundary of the capacity of the heap memory are obtained according to the original capacity of the heap memory, the target capacity of the heap memory is normalized based on the upper boundary and the lower boundary to obtain the normalization value of the target capacity of the heap memory, and the denormalization value of the target capacity of the heap memory is obtained according to the normalization value, the upper boundary, and the lower boundary. The denormalization value is configured as the capacity of the heap memory. Therefore, in the above embodiment, the configured capacity of the heap memory can also be always within the range of the upper boundary and the lower boundary of the capacity of the heap memory, so as to avoid an excessively large adjustment of the capacity of the heap memory, thereby affecting the estimation accuracy of the object promotion rate.

Based on the same inventive concept, an embodiment of the present disclosure further provides a memory management apparatus as an implementation of the above method. The embodiment corresponds to the foregoing method embodiments. For ease of reading, this embodiment does not describe the details in the foregoing method embodiments one by one. However, it should be clear that the memory management apparatus in this embodiment can implement all the content in the foregoing method embodiments.

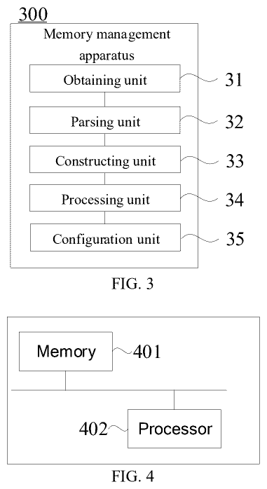

An embodiment of the present disclosure provides a memory management apparatus. FIG. 3 is a schematic structural diagram of the memory management apparatus. As shown in FIG. 3, the memory management apparatus 300 includes:
an obtaining unit 31, configured to obtain log data of garbage collection performed on a heap memory;
a parsing unit 32, configured to obtain an indicator related to an old generation memory usage amount according to the log data;
a constructing unit 33, configured to construct a memory estimation model by using a frequency of the full garbage collection as an independent variable and an estimated capacity of the heap memory as a dependent variable according to the indicator related to the old generation memory usage amount and an original capacity of the heap memory of the heap memory;
a processing unit 34, configured to obtain a target capacity of the heap memory according to the memory estimation model and an expected frequency of the full garbage collection; and
a configuration unit 35, configured to configure a capacity of the heap memory according to the target capacity of the heap memory.

As an optional implementation of the embodiment of the present disclosure, the parsing unit 32 is further configured to obtain a historical promotion rate, a historical application rate, and a historical survival capacity according to the log data;
where the historical promotion rate is a rate at which a young generation memory is promoted to the old generation memory; the historical application rate is an application rate of the old generation memory; and the historical survival capacity is a size of a survivor object after the full garbage collection is performed.

As an optional implementation of the embodiment of the present disclosure, the constructing unit 33 is further configured to construct a first conversion relationship between the estimated capacity of the heap memory and an estimated promotion rate according to the original capacity of the heap memory and the historical promotion rate; construct a second conversion relationship between the frequency of the full garbage collection and the estimated capacity of the heap memory according to the historical survival capacity, the historical application rate, and the estimated promotion rate; and construct the memory estimation model according to the first conversion relationship and the second conversion relationship.

As an optional implementation of the embodiment of the present disclosure, the constructing unit 33 is further configured to obtain a first parameter according to a change amount of the estimated capacity of the heap memory relative to the original capacity of the heap memory; and compensate the historical promotion rate according to the first parameter to obtain the first conversion relationship.

As an optional implementation of the embodiment of the present disclosure, the constructing unit 33 is further configured to obtain a first old generation memory usage amount according to the historical application rate and the frequency of the full garbage collection; obtain a second old generation memory usage amount according to the estimated promotion rate and the frequency of the full garbage collection; construct a conversion relationship between the old generation memory usage amount and the frequency of the full garbage collection according to the first old generation memory usage amount, the second old generation memory usage amount, and the historical survival capacity; and generate the second conversion relationship according to the conversion relationship between the old generation memory usage amount and the frequency of the full garbage collection.

As an optional implementation of the embodiment of the present disclosure, the configuration unit 35 is further configured to: obtain an upper boundary and a lower boundary of the capacity of the heap memory according to the original capacity of the heap memory; determine whether the target capacity of the heap memory is greater than the lower boundary and less than the upper boundary; in response to the target capacity of the heap memory being greater than the lower boundary and less than the upper boundary, configure the target capacity of the heap memory as the capacity of the heap memory; in response to the target capacity of the heap memory being less than or equal to the lower boundary, configure the lower boundary as the capacity of the heap memory; or in response to the target capacity of the heap memory being greater than or equal to the upper boundary, configure the upper boundary as the capacity of the heap memory.

As an optional implementation of the embodiment of the present disclosure, the configuration unit 35 is further configured to: obtain an upper boundary and a lower boundary of the capacity of the heap memory according to the original capacity of the heap memory; normalize the target capacity of the heap memory based on the upper boundary and the lower boundary to obtain a normalization value of the target capacity of the heap memory; obtain a denormalization value of the target capacity of the heap memory according to the normalization value, the upper boundary, and the lower boundary; and configure the denormalization value as the capacity of the heap memory.

As an optional implementation of the embodiment of the present disclosure, the parsing unit 32 is further configured to: parse the log data to obtain a historical garbage collection event; use a K-Means classification algorithm to cluster the historical garbage collection event into two clusters by using an occurrence frequency as a feature; and obtain the indicator related to the old generation memory usage amount through a historical garbage collection event in a cluster with a higher occurrence frequency in the two clusters.

As an optional implementation of the embodiment of the present disclosure, the obtaining unit 31 is further configured to obtain log data of garbage collection performed by the JVM in the stream processing service system.

The memory management apparatus provided in the embodiment of the present disclosure can perform the memory management method according to any one of the above embodiments. The implementation principles and technical effects thereof are similar, and are not described herein again.

Based on the same inventive concept, an embodiment of the present disclosure further provides an electronic device. FIG. 4 is a schematic structural diagram of the electronic device according to the embodiment of the present disclosure. As shown in FIG. 4, the electronic device provided in this embodiment includes: a memory 401 and a processor 402. The memory 401 is configured to store a computer program, and the processor 402 is configured to, when executing the computer program, perform the memory management method according to any one of the above embodiments.

Based on the same inventive concept, an embodiment of the present disclosure further provides a computer-readable storage medium. The computer-readable storage medium is configured to store a computer program. When the computer program is executed by a processor, the computing device is enabled to perform the memory management method according to any one of the above embodiments.

Based on the same inventive concept, an embodiment of the present disclosure further provides a computer program product. When the computer program product runs on a computer, the computing device is enabled to perform the memory management method according to any one of the above embodiments.

A person skilled in the art should understand that the embodiments of the present disclosure may be provided as a method, a system, or a computer program product. Therefore, the present disclosure may be implemented in a form of a complete hardware embodiment, a complete software embodiment, or an embodiment combining software and hardware aspects. Moreover, the present disclosure may be implemented in a form of a computer program product that is implemented on one or more computer-readable storage media including computer-usable program code.

The processor may be a central processing unit (Central Processing Unit, CPU), or may be another general-purpose processor, a digital signal processor (Digital Signal Processor, DSP), an disclosure specific integrated circuit (Disclosure Specific Integrated Circuit, ASIC), a field programmable gate array (Field-Programmable Gate Array, FPGA) or another programmable logic device, a discrete gate or transistor logic device, a discrete hardware component, or the like. The general-purpose processor may be a microprocessor, or the processor may be any conventional processor or the like.

The memory may include a non-permanent memory, a random access memory (RAM) and/or a non-volatile memory in a computer-readable medium, such as a read-only memory (ROM) or a flash memory (flash RAM). The memory is an example of the computer-readable medium.

The computer-readable medium includes a permanent and non-permanent, and a removable and non-removable storage medium. The storage medium may implement information storage by using any method or technology. The information may be a computer-readable instruction, a data structure, a program module, or other data. Examples of the computer storage medium include, but are not limited to, a phase change memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a magnetic cassette, a magnetic disk storage or another magnetic storage device, or any other non-transmission medium, and may be used to store information that can be accessed by the computing device. According to the definition herein, the computer-readable medium does not include transitory computer-readable media (transitory media) such as a modulated data signal and a carrier wave.

Finally, it should be noted that the above embodiments are merely intended to illustrate the technical solutions of the present disclosure, but not to limit the technical solutions. Although the present disclosure has been described in detail with reference to the foregoing embodiments, a person of ordinary skill in the art should understand that the person may still modify the technical solutions described in the foregoing embodiments, or may equivalently replace some or all of the technical features thereof. However, these modifications or replacements do not make the essence of the corresponding technical solutions deviate from the scope of the technical solutions of the embodiments of the present disclosure.

1. A memory management method, comprising:
obtaining log data of garbage collection performed on a heap memory;
obtaining an indicator related to an old generation memory usage amount according to the log data;
constructing a memory estimation model by using a frequency of full garbage collection as an independent variable and an estimated capacity of the heap memory as a dependent variable according to the indicator related to the old generation memory usage amount and an original capacity of the heap memory;
obtaining a target capacity of the heap memory according to the memory estimation model and an expected frequency of the full garbage collection; and
configuring a capacity of the heap memory according to the target capacity of the heap memory.

2. The method according to claim 1, wherein obtaining the indicator related to the old generation memory usage amount according to the log data comprises:
obtaining a historical promotion rate, a historical application rate, and a historical survival capacity according to the log data,
wherein the historical promotion rate is a rate at which a young generation memory is promoted to the old generation memory; the historical application rate is an application rate of the old generation memory; and the historical survival capacity is a size of a survivor object after performing the full garbage collection.

3. The method according to claim 2, wherein constructing the memory estimation model by using the frequency of the full garbage collection as the independent variable and the estimated capacity of the heap memory as the dependent variable according to the indicator related to the old generation memory usage amount and the original capacity of the heap memory comprises:
constructing a first conversion relationship between the estimated capacity of the heap memory and an estimated promotion rate according to the original capacity and the historical promotion rate;
constructing a second conversion relationship between the frequency of the full garbage collection and the estimated capacity of the heap memory according to the historical survival capacity, the historical application rate, and the estimated promotion rate; and
constructing the memory estimation model according to the first conversion relationship and the second conversion relationship.

4. The method according to claim 3, wherein constructing the first conversion relationship between the estimated capacity of the heap memory and the estimated promotion rate according to the original capacity of the heap memory and the historical promotion rate comprises:
obtaining a first parameter according to a change amount of the estimated capacity of the heap memory relative to the original capacity of the heap memory; and
compensating the historical promotion rate according to the first parameter to obtain the first conversion relationship.

5. The method according to claim 3, wherein constructing the second conversion relationship between the frequency of the full garbage collection and the estimated capacity of the heap memory according to the historical survival capacity, the historical application rate, and the estimated promotion rate comprises:
obtaining a first old generation memory usage amount according to the historical application rate and the frequency of the full garbage collection;
obtaining a second old generation memory usage amount according to the estimated promotion rate and the frequency of the full garbage collection;
constructing a conversion relationship between the old generation memory usage amount and the frequency of the full garbage collection according to the first old generation memory usage amount, the second old generation memory usage amount, and the historical survival capacity; and
generating the second conversion relationship according to the conversion relationship between the old generation memory usage amount and the frequency of the full garbage collection.

6. The method according to claim 1, wherein configuring the capacity of the heap memory according to the target capacity of the heap memory comprises:
obtaining an upper boundary and a lower boundary of the capacity of the heap memory according to the original capacity of the heap memory;
determining whether the target capacity of the heap memory is greater than the lower boundary and less than the upper boundary;
in response to the target capacity of the heap memory being greater than the lower boundary and less than the upper boundary, configuring the target capacity of the heap memory as the capacity of the heap memory;
in response to the target capacity of the heap memory being less than or equal to the lower boundary, configuring the lower boundary as the capacity of the heap memory; and
in response to the target capacity of the heap memory being greater than or equal to the upper boundary, configuring the upper boundary as the capacity of the heap memory.

7. The method according to claim 1, wherein configuring the capacity of the heap memory according to the target capacity of the heap memory comprises:
obtaining an upper boundary and a lower boundary of the capacity of the heap memory according to the original capacity of the heap memory;
normalizing the target capacity of the heap memory based on the upper boundary and the lower boundary to obtain a normalization value of the target capacity of the heap memory;
obtaining a denormalization value of the target capacity of the heap memory according to the normalization value, the upper boundary, and the lower boundary; and
configuring the denormalization value as the capacity of the heap memory.

8. The method according to claim 1, wherein obtaining the indicator related to the old generation memory usage amount according to the log data comprises:
parsing the log data to obtain a historical garbage collection event;
using a K-Means classification algorithm to cluster the historical garbage collection event into two clusters by using an occurrence frequency as a feature; and
obtaining the indicator related to the old generation memory usage amount through a historical garbage collection event in a cluster with a higher occurrence frequency in the two clusters.

9. The method according to claim 1, wherein obtaining the log data of the garbage collection performed on the heap memory comprises:
obtaining log data of garbage collection performed by a JVM in a stream processing service system.

10. An electronic device, comprising at least one memory and at least one processor, wherein the at least one memory is configured to store a computer program, and the at least one processor is configured to, when executing the computer program, enable the electronic device to perform a memory management method, and the method comprises:
obtaining log data of garbage collection performed on a heap memory;
obtaining an indicator related to an old generation memory usage amount according to the log data;
constructing a memory estimation model by using a frequency of full garbage collection as an independent variable and an estimated capacity of the heap memory as a dependent variable according to the indicator related to the old generation memory usage amount and an original capacity of the heap memory;
obtaining a target capacity of the heap memory according to the memory estimation model and an expected frequency of the full garbage collection; and
configuring a capacity of the heap memory according to the target capacity of the heap memory.

11. The electronic device according to claim 10, wherein obtaining the indicator related to the old generation memory usage amount according to the log data comprises:
obtaining a historical promotion rate, a historical application rate, and a historical survival capacity according to the log data;
wherein the historical promotion rate is a rate at which a young generation memory is promoted to the old generation memory; the historical application rate is an application rate of the old generation memory; and the historical survival capacity is a size of a survivor object after performing the full garbage collection.

12. The electronic device according to claim 11, wherein constructing the memory estimation model by using the frequency of the full garbage collection as the independent variable and the estimated capacity of the heap memory as the dependent variable according to the indicator related to the old generation memory usage amount and the original capacity of the heap memory comprises:
constructing a first conversion relationship between the estimated capacity of the heap memory and an estimated promotion rate according to the original capacity and the historical promotion rate;
constructing a second conversion relationship between the frequency of the full garbage collection and the estimated capacity of the heap memory according to the historical survival capacity, the historical application rate, and the estimated promotion rate; and
constructing the memory estimation model according to the first conversion relationship and the second conversion relationship.

13. The electronic device according to claim 12, wherein constructing the first conversion relationship between the estimated capacity of the heap memory and the estimated promotion rate according to the original capacity of the heap memory and the historical promotion rate comprises:
obtaining a first parameter according to a change amount of the estimated capacity of the heap memory relative to the original capacity of the heap memory; and
compensating the historical promotion rate according to the first parameter to obtain the first conversion relationship.

14. The electronic device according to claim 12, wherein constructing the second conversion relationship between the frequency of the full garbage collection and the estimated capacity of the heap memory according to the historical survival capacity, the historical application rate, and the estimated promotion rate comprises:
obtaining a first old generation memory usage amount according to the historical application rate and the frequency of the full garbage collection;
obtaining a second old generation memory usage amount according to the estimated promotion rate and the frequency of the full garbage collection;
constructing a conversion relationship between the old generation memory usage amount and the frequency of the full garbage collection according to the first old generation memory usage amount, the second old generation memory usage amount, and the historical survival capacity; and
generating the second conversion relationship according to the conversion relationship between the old generation memory usage amount and the frequency of the full garbage collection.

15. The electronic device according to claim 10, wherein configuring the capacity of the heap memory according to the target capacity of the heap memory comprises:
obtaining an upper boundary and a lower boundary of the capacity of the heap memory according to the original capacity of the heap memory;
determining whether the target capacity of the heap memory is greater than the lower boundary and less than the upper boundary;
in response to the target capacity of the heap memory being greater than the lower boundary and less than the upper boundary, configuring the target capacity of the heap memory as the capacity of the heap memory;
in response to the target capacity of the heap memory being less than or equal to the lower boundary, configuring the lower boundary as the capacity of the heap memory; and
in response to the target capacity of the heap memory being greater than or equal to the upper boundary, configuring the upper boundary as the capacity of the heap memory.

16. The electronic device according to claim 10, wherein configuring the capacity of the heap memory according to the target capacity of the heap memory comprises:
obtaining an upper boundary and a lower boundary of the capacity of the heap memory according to the original capacity of the heap memory;
normalizing the target capacity of the heap memory based on the upper boundary and the lower boundary to obtain a normalization value of the target capacity of the heap memory;
obtaining a denormalization value of the target capacity of the heap memory according to the normalization value, the upper boundary, and the lower boundary; and
configuring the denormalization value as the capacity of the heap memory.

17. The electronic device according to claim 10, wherein obtaining the indicator related to the old generation memory usage amount according to the log data comprises:
parsing the log data to obtain a historical garbage collection event;
using a K-Means classification algorithm to cluster the historical garbage collection event into two clusters by using an occurrence frequency as a feature; and
obtaining the indicator related to the old generation memory usage amount through a historical garbage collection event in a cluster with a higher occurrence frequency in the two clusters.

18. The electronic device according to claim 10, wherein obtaining the log data of the garbage collection performed on the heap memory comprises:
obtaining log data of garbage collection performed by a JVM in a stream processing service system.

19. A non-transitory computer-readable storage medium, storing a computer program, wherein, when the computer program is executed by a computing device, the computing device is enabled to perform a memory management method, and the method comprises:
obtaining log data of garbage collection performed on a heap memory;
obtaining an indicator related to an old generation memory usage amount according to the log data;
constructing a memory estimation model by using a frequency of full garbage collection as an independent variable and an estimated capacity of the heap memory as a dependent variable according to the indicator related to the old generation memory usage amount and an original capacity of the heap memory;
obtaining a target capacity of the heap memory according to the memory estimation model and an expected frequency of the full garbage collection; and
configuring a capacity of the heap memory according to the target capacity of the heap memory.

20. The non-transitory computer-readable storage medium according to claim 19, wherein obtaining the indicator related to the old generation memory usage amount according to the log data comprises:
obtaining a historical promotion rate, a historical application rate, and a historical survival capacity according to the log data,
wherein the historical promotion rate is a rate at which a young generation memory is promoted to the old generation memory; the historical application rate is an application rate of the old generation memory; and the historical survival capacity is a size of a survivor object after performing the full garbage collection.
